(19) United States
(12) Patent Application Publication
(10) Pub. No.: US 2021/0120818 A1
(43) Pub. Date: Apr. 29, 2021

(54) METHOD OF IMPROVING HEALTH AND ROOTING OF HARDWOOD TREES

(71) Applicant: Bayer CropScience LP, St. Louis, MO (US)

(72) Inventors: David SPAK, Cary, NC (US); Harold QUICKE, Windsor, CO (US)

(21) Appl. No.: 17/251,897

(22) PCT Filed: Jun. 13, 2019
(86) PCT No.: PCT/US2019/036913

§ 371 Date: Dec. 14, 2020

Related U.S. Application Data
(63) Continuation of application No. 16/009,451, filed on Jun. 15, 2018, now abandoned.

(51) Int. Cl. A01N 43/68

(52) U.S. Cl. CPC A01N 43/68

(57) ABSTRACT

Methods and compositions for promoting health and development in a hardwood tree.

The present disclosure is related to U.S. patent application Ser. No. 15/871,234, filed Jan. 15, 2018, which describes the use of cellulose biosynthesis inhibitors to promote growth and overall health in pine trees. This application is incorporated by reference in its entirety. Pine trees are a very different species and type of tree compared to hardwoods, and there is no reason to expect a treatment of pine trees would be effective in hardwood trees.

### FIELD

The disclosure provides methods for improving and promoting overall health and development of hardwood trees.

There is an ongoing need for methods of improving plant health to improve overall growth, longevity, fruit/crop yield, ornamental quality, and other desired plant attributes. In particular, there is an ongoing need for methods of improving health and overall growth of hardwood trees, which are employed in a broad range of applications, such as fuel, tools, construction, furniture manufacturing, musical instruments, and flooring. Moreover, many hardwood trees produce useful crops, such as walnuts.

Furthermore, there is an ongoing need for methods of improving plant health as a means of counteracting the possible negative effects of herbicides, such as weed killers.

Herbicides are often necessary for controlling weeds and other undesired plant pests.

However, overuse of herbicides such as weed killers can be damaging not only to the unwanted species, but also to soil and the health, growth, and development of useful and desired plants and crops.

Herbicides can injure foliage, shoots, flowers, and fruits of desired plants. If injury is severe enough, either from one incident or repeated exposure, it may reduce yield, produce poor fruit quality, distort ornamental or nursery plants, and occasionally cause plant death.

Selective herbicides kill specific targets while leaving the desired plant or crop relatively unharmed. Non-selective herbicides, however, are not specific to particular species and instead kill all plant material with which they come into contact.

Cellulose biosynthesis inhibitors such as indaziflam are herbicides, known to be particularly effective at controlling and killing undesired weeds and grasses.

The present inventors have surprisingly found, that herbicides of the class known as cellulose biosynthesis inhibitors, such as indaziflam, when applied as described herein, actively promote plant health, growth, and development of desired hardwood trees.

### SUMMARY

The present invention provides for methods of promoting hardwood tree health and development, wherein a composition comprising, as an active ingredient, a cellulose biosynthesis inhibitor herbicide such as indaziflam, is applied to hardwood tree roots and or soil on top of hardwood tree roots or applied on or near seed or other hardwood tree propagules.

It has surprisingly been found that compositions comprising indaziflam can demonstrate unexpected properties of promoting plant health and development, improving crop yield, and improving plant quality in hardwood trees.

It has also been found that application of compositions comprising indaziflam to hardwood trees does not cause survival issues in the treated hardwood trees.

It has also been found that application of compositions comprising indaziflam to hardwood trees does not cause phytotoxic symptoms in the treated hardwood trees.

The disclosure provides for a method of promoting plant health and development comprising applying to a hardwood tree or habitat thereof a composition comprising a cellulose biosynthesis inhibitor.

The disclosure further provides for a method of promoting plant health and development comprising applying to a hardwood tree or habitat thereof a composition comprising indaziflam.

Further objects, features, and advantages of the invention will become apparent from the detailed description that follows.

### DETAILED DESCRIPTION

Applicants have now found that compositions comprising an herbicide of the class known as cellulose biosynthesis inhibitors, preferably indaziflam, can be applied to seeds of hardwood trees, hardwood trees, and/or parts thereof, and soil which the tree is intended to grow in a manner to promote plant health and development. According to the present invention, any cellulose biosynthesis inhibitor may be used, alone or in combination with other active or inactive ingredients, such as diquat dibromide and glyphosate. Other herbicides may be used in combination with the cellulose biosynthesis inhibitor. For example, sulfometuron can be used in combination with the cellulose biosynthesis inhibitor.

Compositions comprising indaziflam have been recognized as being suitable for generally controlling and inhibiting undesired vegetative growth of plants from seed without simultaneously killing the desirable crop plants. Accordingly, the presently claimed method of promoting plant health and development is surprising in light of the known herbicidal properties and uses of indaziflam-containing products.

The compound, indaziflam, which can be used in the presently claimed method, is described in, for example, U.S. Pat. No. 8,114,991, which is hereby incorporated by reference in its entirety. The compound taught by U.S. Pat. No. 8,114,991 is described therein as having herbicidal properties See U.S. Pat. No. 8,114,991 at, for example, column 62, line 22 to column 72, line 43. This patent teaches that indaziflam is a plant growth regulator, also known as a plant growth retardant. Accordingly, indaziflam's ability to promote plant growth according to the present invention is surprising in light of its known use as a growth retardant.

Indaziflam's International Union of Pure and Applied Chemistry (IUPAC) name is N2-[(1R,2S)-2,3-dihydro-2,6-dimethyl-1H-inden-1-yl]-6-[(1RS)-1-fluoroethyl]-1,3,5-triazine-2,4-diamine. Indaziflam is written chemically as C₁₆H₂₀FN₅.

Indaziflam is an alkylazine compound characterized as a cellulose biosynthesis inhibitor, belonging to Weed Science Society of America (“WSSA”) Mode of Action group 29 (see: http://wssa.net/wp-content/uploads/WSSA-Mechanism-of-Action.pdf).

Additional cellulose biosynthesis inhibitors include herbicides belonging to benzamide (WSSA group 21), nitrile (WSSA group 20), and triazolocarboxamides (WSSA group 28) classes of chemicals. For example, cellulose biosynthesis inhibitors of the benzamide family include isoxaben. Cellulose biosynthesis inhibitors of the nitrile family include dichlobenil and chlorthiamid. Cellulose biosynthesis inhibitors of the triazolocarboxamide family include flupoxam.

Cellulose biosynthesis inhibitor herbicides affect synthesis of the cellulose needed for cell walls in susceptible plants, thereby inhibiting cell division. These herbicides are absorbed through susceptible plants' roots and shoot tissues and inhibit root and shoot growth.

Commercially available herbicides incorporating indaziflam as their active ingredient include, for example, Alion®, Esplanade® F, Esplanade® EZ, Esplanade®200 SC, Specticle® G, Spectile® FLO, Specticle® Total, Specticle® 20 WSP. Marengo®, and DuraZone®. Any of these can be used in the present invention. In a preferred embodiment of the invention, the method uses indaziflam as the only active component. For example, the composition used in the method does not include other herbicides, fungicides, insecticides, or other agriculturally active components.

Indaziflam is known to be useful as a pre-emergence or post-emergence herbicide for annual grasses and broadleaf weeds. Indaziflam has been approved for use on residential and commercial property such as golf courses, lawns, walkways, cemeteries, evergreen nurseries, landscaping projects, and crop and vegetation management markets.

Herbicidal compositions comprising indaziflam are commonly used to control pests such as annual grasses and broadleaf weeds. Indaziflam works well against, for example, crabgrass, goosegrass, kyllinga, bluegrass, doveweed, swinecress, bittercress and henbit, including all weeds listed on the labels of the commercial products.

In contrast to these known uses, it has surprisingly been found that application of indaziflam to a hardwood tree or habitat thereof promotes overall plant health and development, for example, increased root growth and or promotion of mycorrhizae.

The composition comprising a cellulose biosynthesis inhibitor is applied to a hardwood tree or habitat thereof in order to promote overall plant health and development. The composition can include any desired effective amount of the cellulose biosynthesis inhibitor, such as wherein said cellulose biosynthesis inhibitor is present at a concentration of 0.0001% to 75%, or 0.001% to 50%, or 0.01% to 33%, or 0.1% to 20% by weight of the composition.

In another aspect, the disclosure provides for a method described herein, wherein a composition comprising a cellulose biosynthesis inhibitor is applied to a hardwood tree or habitat thereof in order to promote overall plant health and development at a rate which provides the desired results without adversely affecting the desired hardwood tree, for example, at a rate of 0.1 to 10.000 grams of active ingredient per hectare (hereinafter, “g ai/ha”), preferably 1 to 1,000 g ai/ha, preferably 5-750 g ai/ha, or more preferably 10 to 500 g ai/ha or 25-375 g ai/ha or 50-250 g ai/ha.

In an aspect, the active ingredient (“ai”) is one or more cellulose biosynthesis inhibitors.

In an aspect, the cellulose biosynthesis inhibitor is indaziflam.

In an aspect, particularly superior growth response, survival rate, and non-phytotoxic effect are observed in hardwood trees at application rates of between 50-250 g ai/ha of compositions comprising indaziflam as the active ingredient.

In an aspect, compositions described herein may optionally comprise one or more active ingredients in addition to a cellulose biosynthesis inhibitor Exemplary additional active ingredients include 2,4-D, aminopyralid, bromacil, dicamba, diquat dibromide, flumioxazin, fosamine, glufosinate ammonium, glyphosate (glyphosate isopropylamine salt), hexazinone, metsulfuron, picloram, simazine, sulfometuron, and triclopyr.

In an aspect, compositions described herein may include any desired effective amount of one or more additional active ingredients, such as wherein said one or more additional active ingredients is/are present at a combined concentration of 0.001% to 50%, or 0.01% to 33%, or 0.1% to 25% by weight of the composition.

“Plant health” refers to one or more advantageous properties including: emergence, crop yield, protein content, more developed root system (improved root growth), tillering increase, increase in plant height, increase in size of leaf blade, fewer dead basal leaves and/or fruit, stronger tillers, greener leaf color, pigment content, greater photosynthetic activity, decreased need for fertilizer, decrease in need for seeds, more productive tillers, earlier flowering, earlier grain maturity, less plant verse (lodging), increased shoot growth, enhanced plant vigor, increased plant stand and early germination, drought tolerance, and any other advantages familiar to a person skilled in the art.

“Promote,” as used herein in connection with plant health and development, means to advance, increase, facilitate, or otherwise positively impact plant health and, or development, including but not limited to increasing shoot and or root growth, drought tolerance, and or fruit yield.

“Habitat” denotes where a hardwood tree is growing or where a hardwood tree will be grown. The method described herein can be used to treat a hardwood tree or habitat thereof.

The composition comprising a cellulose biosynthesis inhibitor can be formulated in any desired manner and include any desired excipients.

The product used can be a commercial formulation which contains various formulation additives.

The compositions can be formulated as a granular formulation, seed treatment, foliar composition, a foliar spray, solutions, emulsions, suspension, coaling formulation, encapsulated formulation, solid, liquid, fertilizer, paste, powder, suspension, or suspension concentrate The composition may be employed alone or in solid, dispersant, or liquid formulation. In yet another aspect, a composition described herein is formulated as a tank-mix product.

These formulations are produced in any desired or known manner, for example by mixing the active compounds with extenders, such as liquid solvents, pressurized liquefied gases and or solid carriers, optionally with the use of surface-active agents, such as emulsifiers and/or dispersants and or foam formers. If the extender used is water, it is also useful to employ for example organic solvents as cosolvents. Suitable liquid solvents include: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or earners include those liquids which are gaseous at ambient temperature and at atmospheric pressure, for example aerosol propellants such as halogenated hydrocarbons and also butane, propane, nitrogen and carbon dioxide. As solid carriers there are suitable: for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/ or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

In certain embodiments, other ingredients, such as insecticides, fertilizers, biostimulants, and/or soil amendments can be used with the cellulose biosynthesis inhibitor in the methods of the invention.

Any desired useful hardwood tree can be treated by the composition of the present invention to promote the health of the hardwood tree.

“Hardwood tree” is understood as meaning, in the present context, all angiosperm trees. Hardwood trees may be trees which can be obtained by conventional breeding and optimization methods or else by biotechnological and genetic engineering methods or by combinations of these methods, including the transgenic plants and including the plant varieties capable or not capable of being protected by plant breeders' rights.

Hardwood trees include, without limitation, trees of the genera Acacia, Acer, Aesculus, Afzelis, Alnus, Androstachys, Atherosperma, Aucoumea, Berchemia, Betula, Brosimum, Bursers, Buxus, Castanea, Castanospermum, Caesalpinia, Carapa, Cardwellia, Carpinus, Catalpa, Cedrela, Ceratopetalum, Choricarpia, Chloroxylon, Chukrasia, Cinnamomum, Copaifera, Cordia, Cornus, Corymbia, Dalbergia, Diospyros, Distemonanthus, Entandrophragma, Eucalyptus, Eusideroxylon, Fagus, Fraxinus, Gossweilerodendron, Gleditsia, Grevillea, Guaiacum, Guarea, Handroanthus, Hopea, Hymenaea, Intsia, Jacaranda, Juglans, Khaya, Krugiodendron, Leitneria, Liquidambar, Liriodendron, Lyonothamnus, Magnolia, Malus, Marmaroxylon, Melia, Mesua, Microberlinia, Milicia, Nyssa, Ochroma, Ocotea, Olea, Olneya, Ostrya, Oxydendrum, Parrotia, Peltogyne, Platanus, Populus, Prunus, Pterocarpus, Quercus, Robinia, Salix, Santalum, Sassafras, Shorea, Spirostachys, Swietenia, Tabebuia, Tectona, Terminalia, Tilia, Toona, Triplochiton, Ulmus, and Umbellularia.

In an aspect, a composition of the present invention is applied to a hardwood tree of the genera Acer (e.g., maple trees), Castanea (e.g., chestnut trees). Eucalyptus (e.g., eucalyptus trees), Liquidambar (e.g., sweetgum trees), Liriodendron (e.g., magnolia trees), Populus (e.g., poplar, aspen, cottonwoods trees), or Quercus (e.g., oak trees).

In an aspect, the composition of the present invention is applied to a hardwood tree or habitat thereof of one of the Acer species A. vanvolxemii, A. velutinum, A. hyrcanum, A. monspessulanum, A. obtusifolium, A. opalus, A. opulifolium, A. sempervirens, A. syriacum, A. trilobatum, A. barbatum, A. floridanum, A. grandidentatum, A. leucoderme, A. nigrum, A. skuthii, A. saccharum, A. alaskense, A. cissifolium, A. henryi, A. lincolnense, A. douglasense, A. aidzuense, A. ashwilli, A ginnala, A. semenovii, A. tataricum, A. acuminatum, A. argutum, A. barbinerve, A. ivanofense, A. stachyphyllum, A. tetramerum, A. glabrum, A. traini, A. garrettii, A. pinnatinervium, A. laurinum, A. carpinifolium, A. diabolicum, A. franchetti, A. leipoense, A. pilosum, A. sinopurpurascens, A. sterculiaceum, A. villosum, A. yangbiense, A. thomsonii, A. kungshanense, A. tsinglingense, A. lungshengense, A. macrophyllum, A. capillipes, A. castorrivularis, A. caudatifolium, A. clarnoense, A. crataeglfolium, A. davidii, A. forrestii, A. grosseri, A. dettermani, A. hersii, A. komarovii, A. latahense, A. laxiforum, A. micranthum, A. morifolium Koidz., A. maximowiczii, A. palaeorufinerve, A. pectinatum, A. pensylvanicum, A. rubescens, A rufinerve, A. sikkimense, A. tegmentosum, A. tschonoskii, A. eonegundo, A. negundo, A. ceriferum, A. circinatum, A. circumlobatum, A. duplicatoserratum, A. japonicum, A. linganense, A. palmatum, A. pauciflorum, A. pubipalmatum, A. pseudosieboldianum, A. robustum, A. shirasawanum, A. sieboldianum, A. crassum, A. erythranthum, A. eucalyptoides, A. fabri, A. hainanense, A. kiukiangense, A. laevigatum, A. oligocarpum, A. sino-oblongum, A. wangchii, A. calcaratum, A. campbellii, A. chapaense, A. confertifolium, A. eleganiulum, A. erianthum, A. flabellatum, A. fenzelianum, A. kweilinense, A. lampingense, A. mapienense, A. miaoshanicum, A. olivaceum, A. oliverianum, A. schneiderianum, A. serrulatum, A. shangszeense, A. sichourense, A. sinense, A. sunyicnse, A. taipuense, A. tonkinense, A. tutcheri, A. wilsonii, A. wuyuanense, A. yaoshanicum, A. wardii, A. caudatum, A. montanum, A. spicatum, A. ukurunduense, A. distylum, A. nipponicum, A. browni, A. smileyi, A. pentaphyllum, A. albopurpurascens, A. buergerianum, A cinnamomifolium, A. cordatum, A. coriaceifolium, A discolor, A. fengii, A. lucidum, A. oblongum, A paxii, A. shihweii, A. sycopseoides, A. yinkunii, A. yui, A. ambiguum, A. amplum, A. campestre, A. cappadocicum, A. lobelii, A. longipes, A. miaotaiense, A. miyabei, A. mono, A. platanoides, A. nayongense, A. tenellum, A. tibetense, A. truncatum, A. fedschenkoanum, A. pentapomicum, A. pubescens, A. regelii, A. caesium, A. heldreichii, A. pseudoplatanus, A. republicense, A. rousei, A. chaneyi, A. ferrignot, A. kenaicum, A. pycnanthum, A rubrum, A. saccharinum, A. taggarii, A. taurocursum, A. whitebirdense, A. hillsi, A. stewarti, A. stonebergae, A. toradense, A. washingtonense, A. maximowiczianum, A. griseum, A. maximowiczianum, A. nikoense, A. triflorum, A. mandshuricum, or A. sutchuenense.

In an aspect, the composition of the present invention is applied to a hardwood tree or habitat thereof of one of the Castanea species C. dabieshanensis, C. cathayensis, C. humanensis, C. kweichowensis, C. poilanei, C. tonkinensis, C. floridana, C. glabra, C. laciniosa, C. myristiciformis, C. ovalis, C. ovata, C. pallida, C. texana, C. tomentosa, C. washingtonensis, C. aquatic, C. cordiformis, C. illinoinensis, C. palmeri, C. mollissima, C. crenata, C. sativa, C. davidii, C. henryi, C. seguinii, C. pumila, C. alnifolia, C. ashei, C. floridana, or C. paucispina.

In an aspect, the composition of the present invention is applied to a hardwood tree or habitat thereof of one of the Eucalyptus species E. abdita, E. absita, E. acaciiformis, E. accedens, E. acies, E. acmenoides, E. acroleuca, E. aenea, E. aequioperta, E. agglomerata, E. aggregata, E. alatissima, E. alba, E. albens, E. albida, E. albopurpurea, E. alligatrix, E. ammophila, E. amplifolia, E. amygdalina, E. ancophila, E. andrewsii, E. angophoroides, E. angularis, E. angulosa, E. angustissima, E. annulata, E. annuliformis, E. apiculata, E. apodophylla, E. apothalassica, E. approximans, E. aquatica, E. aquilina, E. arachnaea, E. arborella, E. arcana, E. archeri, E. arenacea, E. argillacea, E. argophloia, E. argutifolia, E. argyphea, E. aromaphloia, E. articulate, E. aspersa, E. aspratilis, E. astringens, E. atrata, E. atrovirens, E. aureola, E. australis, E. badjensis, E. baeuerlenii, E. baileyana, E. bakeri, E. balanites, E. balanopelex, E. balladoniensis, E. bancroftii, E. banksii, E. barberi, E. baudiniana, E. baueriana, E. baxteri, E. beaniana, E. beardiana, E. beasleyi, E. behriana, E. bensonii, E. benthamii, E. beyeriana, E. bicostala, E. bigalerita, E. biturbinata, E. blakelyi, E. blaxellii, E. blaxlandii, E. boliviano, E. bosistoana, E. botryoides, E. brachyandra, E. brachycalyx, E. brachycarpa, E. brachycorys, E. brachyphylla, E. brassiana, E. brevifolia, E. brevipes, E. brevistylis, E. bridgesiana, E. brockwayi, E. brookcriana, E. broviniensis, E. brownii, E. buprestium, E. burdettiana, E. burgessiana, E. burracoppmensis, E. cadens, E. caesia, E. cajuputea, E. calcareana, E. calcicola, E. caleyi, E. caliglinosa, E. calycogona, E. calyerup, E. camaldulensis, E. cambageana, E. cameronii, E. camfieldii, E. campanulata, E. campaspe, E. camphora, E. canaliculata, E. Candida, E. cannonii, E. canobolensis, E. capillosa, E. captellata, E. capricornia, E. captiosa, E. carnabyi, E. carnea, E. carnei, E. castrensis, E. celastroides, E. cephalocarpa, E. ceracea, E. cerasiformis, E. ceratocorys, E. cernua, E. champaniana, E. chartaboma, E. chloroclada, E. chlorophylla, E. chrysantha, E. cinerea, E. citriodora, E. cladocalyx, E. clelandii, E. clivicola, E. cloeziana, E. cneorifolia, E. coccifera, E. communalis, E. concinna, E conferruminata, E. confertiflora, E. confluens, E. conglobata, E. conglomerata, E. conica, E. coniophloia, E. conjuncta, E. connerensis, E. consideniana, E. conspicua, E. conveniens, E. coolabah, E. cooperiana, E. copulans, E. cordata, E. cornuta, E. coronata, E. corrugata, E. corticosa, E. corynodes, E. cosmophylla, E. costuligera, E. crebra, E. crenulata, E. creta, E. cretata, E. crispata, E. croajingolensis, E. crucis, E. cullenii, E. cunninghamii, E. cuprea, E. cupularis, E. curtisii, E. cyanoclada, E. cyanophylla, E. cyclostoma, E. cylindriflora, E. cylindrocarpa, E. cypellocarpa, E. dalrympleana, E. darwinensis, E. dawsonii, E. dealbata, E. deanei, E. decipiens, E. decolor, E. decorticans, E. decurva, E. deflexa, E. deglupta, E. delegalensis, E. delicata, E. dendromorphia, E. densa, E. denticulata, E. depauperata, E. derbyensis, E. desmondensis, E. desquamata, E. deuaensis, E. dielsii, E. diminuta, E. diptera, E. discreta, E. dissimulata, E. distans, E. diversicolor, E. diversifolia, E. dives, E. dolichocera, E. dolichorhyncha, E. dolorosa, E. dongarraensis, E. doratoxylon, E. dorrigoensis, E. drummondii, E. drysdalensis, E. dumosa, E. dundasii, E. dunnii, E. dura, E. dwyeri, E. ebbanoensis, E. educta, E. effusa, E. elaeophloia, E. elata, E. ellipsoidea, E. elliptica, E. erectifolia, E. eremicola, E. eremophila, E. erythrandra, E. erythrocorys, E. erythronema, E. eudesmoides, E. eugemoides, E. ewartiana, E. exigua, E. exilipes, E. exilis, E. eximia, E. exserta, E. extensa, E. extrica, E. falcata, E. falciformis, E. famelica, E. fasciculosa, E. fastigata, E. fergusonii, E. ferriticola, E. fibrosa, E. fillformis, E. fitzgeraldii, E. flavida, E. flindersii, E. flocktoniae, E. foecunda, E. foliosa, E. fordeana, E. formanii, E. forrestiana, E. fracta, E. fraseri, E. fraxinoides, E. froggattii, E. fruticosa, E. fulgens, E. fusiformis, E. gamophylla, E. gardneri, E. georgei, E. gigantangion, E. gillenii, E. gillii, E. gittinsii, E. glaucescens, E. glaucina, E. globoidea, E. globulus, E. glomericassis, E. glomerosa, E. gomphocephala, E. gongylocarpa, E. goniantha, E. goniocalyx, E. goniocarpa, E. gracilis, E. grandis, E. granitica, E. grasbyi, E. greeniana, E. gregoriensis, E. gregsoniana, E. griffithsii, E. grisea, E. grossa, E. guilfoylei, E. gunnii, E. gypsophila, E. haemastoma, E. hallii, E. halophila, E. hamersleyana, E. hawkeri, E. hebetifolia, E. helidonica, E. herbertiana, E. histophylla, E. horistes, E. houseana, E. howittiana, E. hypochlamydea, E. hypostomatica, E. ignorabilis, E. imitans, E. imlayenis, E. impensa, E. incerata, E. incrassata, E. indurata, E. infera, E. insularis, E. interstans, E. intertexta, E. intrasilvatica, E. jacksonii, E. jensenii, E. jimberlanica, E. johnsoniana, E. johnstonii, E. jucunda, E. jutsonii, E. kabiana, E. kakadu, E. kartzoffiana, E. kenneallyi, E. kessellii, E. kingsmillii, E. kitsoniana, E. kochii, E. kondininensis, E. koolpinensis, E. kruseana, E. kumarlensis, E. kybeanensis, E. lacrimans, E. laeliae, E. laevis, E. laevopinea, E. ane-poolei, E. langleyi, E. lansdowneana, E. largeana, E. largiflorens, E. latens, E. lateritica, E. latisinensis, E. lehmannii, E. leprophloia, E. leptocalyx, E. leptophleba, E. leptophylla, E. leptopoda, E. lesouefii, E. leucophloia, E. leucophylla, E. leucoxylon, E. ligulata, E. ligustrina, E. limitaris, E. lirata, E. litoralis, E. litorea, E. livida, E. lockyeri, E. longicornis, E. longifolia, E. longirostrata, E. loxophleba, E. lucasii, E. lucens, E. luculenta, E. luehmanniana, E. luteola, E. macarthurii, E. mackintii, E. macquoidii, E. macrandra, E. macrocarpa, E. macrorhyncha, E. magnificata, E. maidenii, E. major, E. malacoxylon, E. mannensis, E. mannifera, E. margmata, E. mckieana, E. mcquoidii, E. medialis, E. mediocris, E. megacarpa, E. megacornuta, E. melanoleuca, E. melanophitra, E. melanophloia, E. melanoxylon, E. melliodora, E. mensalis, E. merrickiae, E. michaeliana, E. micranthera, E. microcarpa, E. microcorys, E. microneura, E. microschema, E. microtheca, E. mimica, E. miniata, E. misella, E. mitchelliana, E. moderata, E. moluccana, E. mooreana, E. moorei, E morrisbyi, E. morrisii, E. muelleriana, E. multicaulis, E. myriadena, E. nandewarica, E. neglecta, E. nelsonii, E. neutra, E. newbeyi, E. nicholii, E. nigrifunda, E. nitens, E. nitida, E. nobilis, E. normantonensis, E. nortonii, E. notabilis, E. nova-anglica, E. novoguinensis, E. nubila, E. nutans, E. obconica, E. obesa, E. obliqua, E. oblonga, E. obstans, E. obtusiflora, E. occidentalis, E. ochrophloia, E. odontocarpa, E. odorata, E. oldfieldii, E. oleosa, E. olida, E. oligantha, E. olivina, E. ollaris, E. olsenii, E. ophitica, E. optima, E. oraria, E. orbifolia, E. ordiana, E. oreades, E. orgadopbila, E. orientalis, E. ornata, E. ovata, E. ovularis, E. oxymitra, E. pachycalyx, E. pachyloma, E. pachyphylla, E. paedoglauca, E. paliformis, E. paludicola, E. panda, E. paniculata, E. pantolcuca, E. paralimnetica, E. parramattensis, E. parvula, E. patellaris, E. patens, E. pauciflora, E. pauciseta, E. peeneri, E. pellita, E. pendens, E. peninsularis, E. perangusta, E. percostata, E. perriniana, E. persistens, E. petiolaris, E. petraea, E. petrensis, E. phaenophylla, E. phenax, E. phoenicea, E. phylacis, E. pilbarensis, E. pileata, E. pilligaensis, E. pilularis, E. pimpiniana, E. piperita, E. placita, E. planchoniana, E. planipes, E. platycorys, E. platyphylla, E. platypus, E. plenissima, E. pleurocarpa, E. pleurocorys, E. pluricaulis, E. polita, E. polyanthemos, E. polybractea, E. pontis, E. populnea, E. porosa, E. portuensis, E. praecox, E. praetermissa, E. prava, E. preissiana, E. prolixa, E. prominens, E. propinqua, E. protensa, E. provecta, E. pruiniramis, E. pruinosa, E. psammitica, E. pseudoglobulus, E. pterocarpa, E. pulchella, E. pulverulenta, E. pumila, E. punctata, E. pyrenea, E. pyriformis, E. pyrocarpa, E. quadrangulata, E. quadrans, E. quadricostata, E. quaerenda, E. quinniorum, E. racemosa, E. radiata, E. rameliana, E. rariflora, E. raveretiana, E. ravida. E. recta, E. recurva, E. redacta, E. redimiculifera, E. reducta, E. redunca, E. regnans, E. relicta, E. remota, E. repullulans, E. resinifera, E. retinens, E. rhodantha, E. rhombica, E. rhomboidea, E. rigens, E. rigidula, E. risdonii, E. rivularis, E. robusta, E. rodwayi, E. rosacea, E. rossii, E. roycei, E. rubida, E. rubiginosa, E. rudderi, E. rudis, E. rugosa, E. rummeryi, E. rupestris, E. salicola, E. saligna, E. salmonophloia, E. salubris, E. sargentii, E. saxatilis, E. scias, E. scoparia, E. scyphocalyx, E. seeana, E. selachiana, E. semota, E. sepulcralis, E. serraensis, E. sessilis, E. sheathiana, E. shirleyi, E. sicilifolia, E. siderophloia, E. sideroxylon, E. sieberi, E. signata, E. similis, E. singularis, E. sinuosa, E. smithii, E. socialis, E. sparsa, E. sparsicoma, E. sparsifolia, E. spathulata, E. sphaerocarpa, E. splendens, E. sporadica, E. spreta, E. squamosa, E. staeri, E. staigeriana, E. steedmanii, E. stellulata, E. stenostoma, E. stoatei, E. stowardii, E. striaticalyx, E. stricklandii, E. stricta, E. strzeleckii, E. sturgissiana, E. subangusta, E. subcrenulata, E. suberea, E. sublucida, E. subtilis, E. suffulgens, E. suggrandis, E. surgens, E. symonii, E. synandra, E. talyuberlup, E. tardeadens, E. taurina, E. tectifica, E. tenella, E. tenera, E. tenuipes, E. tenuiramis, E. tenuis, E. tephroclada, E. tephrodes, E. terebra, E. tereticornis, E. terrica, E. tetragona, E. tetrapleura, E. tetraptera, E. tetrodonta, E. thamnoides, E. tholiformis, E. thozetiana, E. tindaliae, E. tinghaensis, E. tintinnans, E. todtiana, E. tokwa, E. torquata, E. tortilis, E. trachybasis, E. transcontinentalis, E. tricarpa, E. triflora, E. trivalvis, E. tumida, E. ultima, E. umbra, E. umbrawarrensis, E. uncinata, E. urna, E. urnigera, E. urnularis, E. urophylla, E. utilis, E. uvida, E. valens, E. varia, E. vegrandis, E. vernicosa, E. verrucata, E. vesiculosa, E. vicina, E. victoriana, E. victrix, E. viminalis, E. virens, E. virginea, E. viridis, E. vokesensis, E. volcanica, E. walshii, E. wandoo, E. websteriana, E. whitei, E. wilcoxii, E. williamsiana, E. willisii, E. woodwardii, E. wubinensis, E. wyolensis, E. xanthoclada, E. xanthonema, E. xerothermica, E. yalatensis, E. yarraensis, E. yilgarnensis, E. youmanii, E. youngiana, E. yumbarrana, or E. zopherophloia.

In an aspect, the composition of the present invention is applied to a hardwood tree or habitat thereof of one of the Liquidambar species L. acalycina, L. changii, L. formosana, L. orientalis, or L. styraciflua,

In an aspect, the composition of the present invention is applied to a hardwood tree or habitat thereof of either of the Liriodendron species L. chinense or L. tulipifera.

In an aspect, the composition of the present invention is applied to a hardwood tree or habitat thereof of one of the Populus species P. deltoides, P. femontii, P. nigra, P. hybrid, P. adenopoda, P. alba, P. davidiana, P. grandidentata, P. sieboldii, P. tremula, P. tremuloides, P. angustifolia, P. balsamifera, P. cathayana, P. koreana, P. laurifolia, P. maximowiczii, P. simonii, P. suaveolens, P. szechuanica, P. trichocarpa, P. tristis, P. ussuriensis, P. yunnanensis, P. heterophylla, P. lasiocarpa, P. wilsonii, P. euphratica, P. ilicfolia, P. guzmanantlensis, or P. mexicana.

In an aspect, the composition of the present invention is applied to a hardwood tree of one of the Quercus species Q. ajoensis., Q. alba, Q. aliena, Q. arizonica, Q. austrina, Q. berberidifolia, Q. bicolor, Q. boyntonii, Q. brandegeei, Q. carmenensis, Q. chapmanil, Q. chihnahuensis, Q. cornelius-mulleri, Q. conzattii, Q. copeyensis, Q. dalechampii, O. depressipes, Q. deserticola, Q. diversifolia, Q. douglasii, Q. dumosa, Q. durata, Q. engelmannii, Q. fabrei, Q. faginea, Q. furuhjelmi, Q. fusiformis, Q. gambelii, Q. garryana, Q. geminate, Q. glaucoides, Q. greggii, Q. grisea, Q. hartwissiana, Q. havardii, Q. hiholensis, Q. hinckleyi, Q. hondurensis, Q. ilex, Q. insignis, Q. intricate, Q. john-tuckeri, Q. laceyi, Q. laeta, Q. lanata, Q. leucotrichophora, Q. liebmannii, Q. lobate, Q. lusitanica, Q. lyrate, Q. macrocarpa, Q. margarettae, Q. magnoliifolia, Q. martinezii, Q. mohriana, Q. montana, Q. michauxii, Q. microphylla, Q. minima, Q. mongolica, Q. muehlenbergii, Q. oblongifolia, Q. obtusata, Q. oglethorpensis, Q. oleoides, Q. pacifica, Q. peduncularis, Q. petraea, Q. polymorpha, Q. praeco, Q. prinoides, Q. pubescens, Q. pungens, Q. robur, Q. rugosa, Q. sadleriana, Q. sagraeana, Q. sebifera, Q. serrata, Q. similis, Q. sinuate, Q. stellate, Q. tarahumara, Q. toumeyi, Q. turbinella, Q. vaseyana, Q. virginiana, Q. welshii, Q. canariensis, Q. dentata,. Q. frainetto, Q. macranthera, Q. pontica, Q. pyrenaica, Q. vulcanica, Q. acutissima, Q. alnifolia, Q. brantii, Q. calliprinos, Q. castaneifolia, Q. cerris, Q. coccifera, Q. franchetii, Q. infectoria, Q. infectoria, Q. ithaburensis, Q. libani, Q. macrolepis, Q. semecarpifolia, Q. suber, Q. trojana, Q. variabilis, Q. cedrosensis, Q. chrysolepis, Q. palmeri, Q. tomentella, Q. vacciniifolia, Q. acerifolia, Q. acutifolia, Q. agrifolia, Q. albocincta, Q. aristate, Q. arkansana, Q. buckleyi, Q. canbyi, Q. candicans, Q. castanea, Q. coccinea, Q. coccolobifolia, Q. coffeicolor, Q. conspersa, Q. costaricensis, Q. crassifolia, Q. crassipes, Q. cualensis, Q. delgadoana, Q. depressa, Q. dysophylla, Q. eduardii, Q. ellipsoidalis, Q. elliptica, Q. emoryi, Q. epileuca, Q. excels, Q. falcata, Q. frutex, Q. fulva, Q. gentry, Q. glabrescens, Q. glaucoides, Q. gravesii, Q. graciliformis, Q. georgiana, Q. hemisphaerica, Q. hintonii, Q. hintoniorum, Q. hirtifolia, Q. humboldtii, Q. hypoleucoides, Q. hypoxantha, Q. ilicifolia, Q. iltisii, Q. imbricaria, Q. incana, Q. inopina, Q. kelloggii, Q. laevis, Q. laurifolia, Q. laurina, Q. marilandica, Q. martinezii, Q. mexicana, Q. myrtifolia, Q. nigra, Q. oocarpa, Q. pagoda, Q. parvula, Q. palustris, Q. peduncularis, Q. phellos, Q. planipocula, Q. potosina, Q. praeco, Q. pumila, Q. rapurahuensis, Q. resinosa, Q. robusta, Q. rysophylla, Q. rubra, Q. salicifolia, Q. sapotifolia, Q. scytophylla, Q. shumardii, Q. splendens, Q. skiineri, Q. subspathulata, Q. tardifolia, Q. texana, Q. tuberculate, Q. urbanii, Q. uxoris, Q. velutina, Q. viminea, Q. wislizeni, Q. xalapensis, Q. acuta, Q. albicaulis, Q. annulate, Q. arbutifolia, Q. argentata, Q. argyrotricha, Q. asymmetrica, Q. augustinii, Q. auricoma, Q. austrocochinchinensois, Q. austroglauca, Q. bella, Q. blakei, Q. braianensis, Q. championii, Q. chapensis, Q. chevalieri, Q. chingsiensis, Q. chrysocalyx, Q. chungii, Q. daimingshanensis, Q. dankiaensis, Q. delavayi, Q. delicatula, Q. dinghuensis, Q. disciformis, Q. edithiae, Q. elevaticostata, Q. fleuryi, Q. gambleana, Q. gemelliflora, Q. gilva, Q. glauca, Q. gomeziana, Q. helferiana, Q. hondae, Q. hypophaea, Q. jenseniana, Q. jinpinensis, Q. kerrii, Q. kiukiangensis, Q. kouangsiensis, Q. lamellose, Q. lanata, Q. langbianensis, Q. lineata, Q. litoralis, Q. litseoides, Q. lobbii, Q. longinux, Q. lowii, Q. lungmaiensis, Q. macrocalyx, Q. merrillii, Q. mespilifolia, Q. morii, Q. motuoensis, Q. multinervis, Q. myrsinifolia, Q. ningangensis, Q. oblongata. Q. obovatifolia, Q. oxyodon, Q. pachyloma, Q. patelliformis, Q. pentacycla, Q. petelotii, Q. phanera, Q. poilanei, Q. quangtriensis, Q. rex, Q. rupestris, Q. salicina, Q. saravanensis, Q. schottkyana, Q. semiserrata, Q. sessilifolia, Q. setulosa, Q. sichourensis, Q. stenophylloides, Q. stewardiana, Q. subhinoidea, Q. subsericea, Q. sumatrana, Q. thorelii, Q. tomentosinervis, Q. treubiana, Q. xanthotricha, or Q. yingjiangensis.

In an aspect, a composition of the present invention is applied to a hardwood tree of habitat thereof of the species Acer pseudoplatanus (sycamore), Acer rubrum (red maple), Castanea mollissima (Chinese chestnut),Eucalyptus benthamii (eucalyptus), Liquidambar styraciflua (sweetgum), Liriodendron tulipifera (yellow poplar), P. deltoides (cottonwood), P. hybrid (hybrid poplar), Quercus. alba (white oak), Quercus falcata var. pagodaefolia cherry bark oak), or Quercus montana (chestnut oak).

A composition described herein can be applied to a soil, hardwood tree, or a seed, leaf, or part thereof in a single application step. In another aspect, a composition described herein is applied to a hardwood tree or a seed, leaf, or part thereof in multiple application steps, for example, two, three, four, five or more application steps. In another aspect, the second, third, fourth, or fifth or more application steps may be with the same or different compositions The methods described herein also provide for an aspect where multiple application steps are excluded.

A composition described herein can be applied to a soil, hardwood tree, or a seed, or part thereof in one or more application intervals of about 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 35 days, about 45 days, about 50 days, or about 56 days.

A composition described herein can be applied to a hardwood tree, or a seed, leaf, or part thereof one or more times during a growing, planting, or harvesting season. In another aspect, a compound or composition described herein is applied to a hardwood tree, crop, seed, or plant part thereof in one, two, three, four, or five or more times during a growing, planting, or harvesting season. In another aspect, a compound or composition described herein is applied to a plant, crop, seed, or plant part thereof only one time, no more than two times, or no more than three times during a growing, planting, or harvesting season. In yet another aspect, a compound or composition is applied in a single step to a seed. In yet another aspect, a seed described herein is planted in a one-pass application step.

In an aspect, a composition of the present invention is applied to a hardwood tree as a pre-plant treatment, e.g. before the tree is planted.

In another aspect, a composition of the present invention is applied to a hardwood tree as a post-plant treatment, e.g. after the tree is planted, or can be applied before and after planting.

In another aspect, the disclosure provides for pre-plant, pre-emergent, post-emergent, application steps or combinations thereof. In another aspect, a compound or composition described herein is first applied in a pre-plant step and followed by one or more pre-emergent or post-emergent steps.

Methods described herein can be used in the treatment of genetically modified organisms (GMOs), e.g., plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

In an aspect, plants can be obtained by traditional breeding and optimization methods or by biotechnological and recombinant methods, or combinations of these methods, including the transgenic plants and including the plant varieties which are capable or not capable of being protected by Plant Breeders' Rights.

In another aspect, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated.

“Plant parts” should be understood as meaning all above ground and subsoil parts and organs of plants, such as shoot, leaf, flower, root, leaves, needles, stalks, stems, fruiting bodies, fruits and seeds, tubers and rhizomes. Plant parts also include harvested crops, and also vegetative and generative propagation material, for example cuttings, tubers, rhizomes, slips and seeds.

Seeds, plant parts, leaves, and plants may be treated with the described compositions by applying the compounds or compositions directly to the seed, plant part, leaf, or plant. In another aspect, the seed, plant part, leaf, or plant may be treated indirectly, for example by treating the environment or habitat in which the seed, plant part, leaf, or plant is exposed to. Conventional treatment methods may be used to treat the environment or habitat including dipping, spraying, fumigating, chemigating, fogging, scattering, brushing on, shanking or injecting.

“Habitat” denotes where a hardwood tree is growing or where a hardwood tree will be grown. The composition can be used to treat the hardwood tree, or a seed, leaf, part, or habitat thereof.

According to the invention, the treatment of the hardwood trees and seeds, leases or parts thereof with a composition described herein can be carried out directly by the customary treatment methods, for example by immersion, spraying, vaporizing, fogging, injecting, dripping, drenching, broadcasting or painting, and seed treatment.

A compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

A composition disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematacide, a nutritional or horticultural supplement, or any combination thereof. In an aspect, a composition described herein is odor free.

Compositions described herein can be combined with a fertilizer. Examples of fertilizers capable of being used with the compositions and methods described herein include, for example, urea, ammonium nitrate, ammonium sulfate, calcium nitrate, diammonium phosphate, monoammonium phosphate, triple super phosphate, potassium nitrate, potassium nitrate, nitrate of potash, potassium chloride, muriate of potash, di- and mono- potassium salts of phosphite/phosphonate.

As demonstrated in the below Examples, it has been found by the inventors that there is a rate response indicating that there is a biologically unique response that has an optimum concentration or application rates of cellulose biosynthesis inhibitors. Accordingly, it has been found that negative effects may be observed at increased concentrations or application rates. Likely because cellulose biosynthesis inhibitors are herbicides, negative impacts on plant health have been found above a certain threshold for a particular hardwood tree. The optimum concentration or application rate of, for example, indaziflam, for promoting plant growth while reducing negative effects, in view of the present disclosure, would be readily determinable by a person of skill in the art.

The following examples serve to illustrate certain aspects of the disclosure and are not intended to limit the disclosure.

### EXAMPLES

In the following Examples, hardwood tree seeds were treated either pre-planting or post-planting with either 5 oz/acre (73 g ai/ha), 7 oz/acre (102 g ai/ha), or 14 oz/acre (204 g ai/ha) of Esplanade® F.

All plots in which seeds were planted were pre-treated with hand-pulling and or glyphosate sprays to minimize weed pressure and therefore isolate the effects of Esplanade® F on tree growth.

All trees were planted as bare root seedlings, except for eucalyptus (Eucalyptus benthamii) and hybrid poplar (Populus hybrid). Each eucalyptus seedling was containerized and planted with an intact root plug. Hybrid poplar seedlings were planted as stem cuttings

For planting, a dibble was used to make a planting slit. Bare roots, plugs (i.e., eucalyptus) or stem cuttings (i.e., hybrid poplar) were placed into the slits and soil was tamped down around the seedlings. No surface soil was removed prior to making the slits.

Stem volume index is calculated as D²H where D=groundline stem diameter and H=total height

Post-plant treatments were performed pre-budbreak on all species with the exception of eucalyptus, which is an indeterminate species.

### Example 1—Growth Response for Pre-Plant Treatments

Table 1 summarizes growth response data for pre-plant treatments. Esplanade® F was sprayed and trees were planted between 4 and 5 months thereafter Esplanade F is a commercially available herbicide provided by Bayer, marketed for preemergent weed control in conifer and hardwood production areas. Esplanade F contains indaziflam as its sole active ingredient in a concentration of 19.05% by weight of the composition.

TABLE 1
Growth Response for Pre-Plant Treatments Stem Volume Index Reported in cm³

| | | | 73 g ai/ha | | 102 g ai/ha | | 204 g ai/ha | |
|---|---|---|---|---|---|---|---|---|
| | Untreated | | (5 oz) | | (7 oz) | | (14 oz) | |
| Yellow Poplar | 29.35 | cm³ | 41.47 | cm³ | 35.3 | cm³ | 23.61 | cm³ |
| (Liriodendron | | | | | | | | |
| tulipifera) | | | | | | | | |
| Red Maple | 7.65 | cm³ | 14.83 | cm³ | 14.07 | cm³ | 4.52 | cm³ |
| (Acer rubrum) | | | | | | | | |
| White Oak | 28.52 | cm³ | 54.05 | cm³ | 23.12 | cm³ | 59.55 | cm³ |
| (Quercus alba) | | | | | | | | |
| Cherrybark Oak | 21.05 | cm³ | 41.48 | cm³ | 18.42 | cm³ | 25.98 | cm³ |
| (Quercus falcata | | | | | | | | |
| var. | | | | | | | | |
| pagodaefolia) | | | | | | | | |
| Sweetgum | 53.5 | cm³ | 103.78 | cm³ | 79.67 | cm³ | 72.4 | cm³ |
| (Liquidambar | | | | | | | | |
| styraciflua) | | | | | | | | |
| Eucalyptus | 129.88 | cm³ | 923.24 | cm³ | 385.84 | cm³ | 143.68 | cm³ |
| (Eucalyptus | | | | | | | | |
| benthamii) | | | | | | | | |
| Cottonwood | 68.86 | cm³ | 124.55 | cm³ | 72.13 | cm³ | 361.05 | cm³ |
| (Populus | | | | | | | | |
| deltoides) | | | | | | | | |
| Sycamore | 140.85 | cm³ | 378.13 | cm³ | 187.12 | cm³ | 243.18 | cm³ |
| (Acer | | | | | | | | |
| pseudoplatanus) | | | | | | | | |
| Hybrid Poplar | 222.28 | cm³ | 785.76 | cm³ | 362.42 | cm³ | 636.39 | cm³ |
| (Populus hybrid) | | | | | | | | |

The results shown in the above table demonstrate that pre-plant treatment methods according to the invention induce positive growth responses, in hardwood trees.

Indeed, a positive growth response was induced in all tested species at one or more of the tested application rates.

### Example 2—Growth Response for Post-Plant Treatments

Table 2 summarizes growth response data for post-plant treatments. Trees were planted and Esplanade® F was sprayed between 1 and 4 weeks thereafter.

TABLE 2
Growth Response for Post-Plant Treatments Stem Volume Index Reported in cm³

| | | | 73 g ai/ha | | 102 g ai/ha | | 204 g ai/ha | |
|---|---|---|---|---|---|---|---|---|
| | Untreated | | (5 oz) | | (7 oz) | | (14 oz) | |
| Yellow Poplar | 29.35 | cm³ | 31.75 | cm³ | 31.51 | cm³ | 36.63 | cm³ |
| (Liriodendron | | | | | | | | |
| tulipifera) | | | | | | | | |
| Red Maple | 7.65 | cm³ | 14.07 | cm³ | 11.22 | cm³ | 10.71 | cm³ |
| (Acer rubrum) | | | | | | | | |
| White Oak | 28.52 | cm³ | 36.4 | cm³ | 27.48 | cm³ | 46.81 | cm³ |
| (Quercus alba) | | | | | | | | |
| Cherrybark Oak | 21.05 | cm³ | 25.93 | cm³ | 14.79 | cm³ | 21.84 | cm³ |
| (Quercus falcata | | | | | | | | |
| var. | | | | | | | | |
| pagodaefolia) | | | | | | | | |
| Sweetgum | 53.5 | cm³ | 89.83 | cm³ | 46.12 | cm³ | 84.11 | cm³ |
| (Liquidambar | | | | | | | | |
| styraciflua) | | | | | | | | |
| Eucalyptus | 129.88 | cm³ | 278.99 | cm³ | 374.62 | cm³ | 359.12 | cm³ |
| (Eucalyptus | | | | | | | | |
| benthamii) | | | | | | | | |
| Cottonwood | 68.86 | cm³ | 135.43 | cm³ | 109.86 | cm³ | 105.94 | cm³ |
| (Populus | | | | | | | | |
| deltoides) | | | | | | | | |
| Sycamore | 140.85 | cm³ | 294.19 | cm³ | 244.78 | cm³ | 196.93 | cm³ |
| (Acer | | | | | | | | |
| pseudoplatanus) | | | | | | | | |
| Hybrid Poplar | 222.28 | cm³ | 749.11 | cm³ | 227.96 | cm³ | 290.84 | cm³ |
| (Populus hybrid) | | | | | | | | |

The results shown in the above table demonstrate that post-plant treatment methods according to the invention induce positive growth responses in hardwood trees.

Indeed, a positive growth response was induced in all tested species at one or more of the tested application rates.

### Example 3—Survival Rate for Pre-Plant Treatments

Table 3 summarizes survival rate data for pre-plant treatments. Esplanade® F was sprayed and trees were planted between 4 and 5 months thereafter.

TABLE 3
Survival Rate for Pre-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 63.3% | 90.0% | 93.3% | 76.7% |
| (Liriodendron | | | | |
| tulipifera) | | | | |
| Red Maple | 83.3% | 76.7% | 86.7% | 46.7% |
| (Acer rubrum) | | | | |
| White Oak | 76.7% | 80.0% | 30.0% | 50.0% |
| (Quercus alba) | | | | |
| Cherrybark Oak | 80.0% | 73.3% | 73.3% | 90.0% |
| (Quercus falcata | | | | |
| var. | | | | |
| pagodaefolia) | | | | |
| Sweetgum | 66.7% | 83.3% | 93.3% | 66.7% |
| (Liquidambar | | | | |
| styraciflua) | | | | |
| Eucalyptus | 73.3% | 73.3% | 70.0% | 60.0% |
| (Eucalyptus | | | | |
| benthamii) | | | | |
| Cottonwood | 70.0% | 90.0% | 76.7% | 60.0% |
| (Populus | | | | |
| deltoides) | | | | |
| Sycamore | 96.7% | 96.7% | 100% | 100% |
| (Acer | | | | |
| pseudoplatanus) | | | | |
| Hybrid Poplar | 86.7% | 100% | 90.0% | 90.0% |
| (Populus hybrid) | | | | |

The results shown in the above table demonstrate that pre-plant treatment methods according to the invention are safe for use in hardwood trees.

### Example4—Survival Rate for Post-Plant Treatments

Table 4 summarizes survival rate data for post-plant treatments. Trees were planted and Esplanade® F was sprayed between 1 and 4 weeks thereafter.

TABLE 4
Survival Rate for Post-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 63.3% | 76.7% | 86.7% | 76.7% |
| (Liriodendron | | | | |
| tulipifera) | | | | |
| Red Maple | 83.3% | 83.3% | 93.3% | 63.3% |
| (Acer rubrum) | | | | |
| White Oak | 76.7% | 63.3% | 56.7% | 83.3% |
| (Quercus alba) | | | | |
| Cherrybark Oak | 80.0% | 83.3% | 66.7% | 73.3% |
| (Quercus falcata | | | | |
| var. | | | | |
| pagodaefolia) | | | | |
| Sweetgum | 66.7% | 66.7% | 83.3% | 50.0% |
| (Liquidambar | | | | |
| styraciflua) | | | | |
| Eucalyptus | 73.3% | 73.3% | 66.7% | 50% |
| (Eucalyptus | | | | |
| benthamii) | | | | |
| Cottonwood | 70.0% | 86.7% | 86.7% | 80.0% |
| (Populus | | | | |
| deltoides) | | | | |
| Sycamore | 96.7% | 100% | 100% | 93.3% |
| (Acer | | | | |
| pseudoplatanus) | | | | |
| Hybrid Poplar | 86.7% | 86.7% | 76.7% | 93.3% |
| (Populus hybrid) | | | | |

The results shown in the above able demonstrate that post-plant treatment methods according to the invention are safe for use in hardwood trees.

### Example 5—Phytotoxicity for Pre-Plant Treatments

Table 5 summarizes phytotoxicity data for pre-plant treatments. Esplanade® F was sprayed and trees were planted between 4 and 5 months thereafter. Phytotoxicity was assessed on a scale of 1 to 10.

TABLE 5
Phytotoxicity for Pre-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 3.17 | 2.4 | 2.1 | 1.77 |
| (Liriodendron | | | | |
| tulipifera) | | | | |
| Red Maple | 1.5 | 2.23 | 1.33 | 5.07 |
| (Acer rubrum) | | | | |
| White Oak | 2.9 | 3.0 | 6.77 | 5.3 |
| (Quercus alba) | | | | |
| Cherrybark Oak | 3.03 | 3.43 | 4.8 | 2.03 |
| (Quercus falcata | | | | |
| var. | | | | |
| pagodaefolia) | | | | |
| Sweetgum | 3.67 | 2.0 | 1.03 | 3.8 |
| (Liquidambar | | | | |
| styraciflua) | | | | |
| Eucalyptus | 2.33 | 3.37 | 3.2 | 4.17 |
| (Eucalyptus | | | | |
| benthamii) | | | | |
| Cottonwood | 1.73 | 0.93 | 2.5 | 3.5 |
| (Populus | | | | |
| deltoides) | | | | |
| Sycamore | 1.03 | 1.07 | 0.87 | 0.77 |
| (Acer | | | | |
| pseudoplatanus) | | | | |
| Hybrid Poplar | 0.97 | 0.5 | 1.37 | 1.2 |
| (Populus hybrid) | | | | |

The results shown in the above table demonstrate that pre-plant treatment methods according to the invention are safe for use in hardwood trees.

### Example 6—Phytotoxicity For Post-Plant Treatments

Table 6summarizes phytotoxicity data for post-plant treatments. Trees were planted and Esplanade® F was sprayed between 1 and 4 weeks thereafter. Phytotoxicity was assessed on a scale of 1 to 10.

TABLE 6
Phytotoxicity for Post-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 3.17 | 2.7 | 2.2 | 3.17 |
| (Liriodendron | | | | |
| tulipifera) | | | | |
| Red Maple | 1.5 | 2.7 | 1.7 | 4.13 |
| (Acer rubrum) | | | | |
| White Oak | 2.9 | 3.37 | 5.87 | 2.3 |
| (Quercus alba) | | | | |
| Cherrybark Oak | 3.03 | 2.33 | 4.03 | 4.63 |
| (Quercus falcata | | | | |
| var. | | | | |
| pagodaefolia) | | | | |
| Sweetgum | 3.67 | 3.93 | 2.0 | 5.03 |
| (Liquidambar | | | | |
| styraciflua) | | | | |
| Eucalyptus | 2.33 | 2.3 | 3.3 | 5.67 |
| (Eucalyptus | | | | |
| benthamii) | | | | |
| Cottonwood | 1.73 | 1.53 | 1.4 | 2.43 |
| (Populus | | | | |
| deltoides) | | | | |
| Sycamore | 1.03 | 0.97 | 0.63 | 1.4 |
| (Acer | | | | |
| pseudoplatanus) | | | | |
| Hybrid Poplar | 0.97 | 1.63 | 1.33 | 0.93 |
| (Populus hybrid) | | | | |

The results shown in the above table demonstrate that post-plant treatment methods according to the invention are safe for use in hardwood trees.

### Example 7—Growth Response for Pre-Plant Treatments

Table 7 summarizes growth response data for pre-plant treatments. Esplanade® F was sprayed and trees were planted between 4 and 5 months thereafter.

TABLE 7
Growth Response for Pre-Plant Treatments
Stem Volume Index Reported in cm³

| | | | 73 g ai/ha | | 102 g ai/ha | | 204 g ai/ha | |
|---|---|---|---|---|---|---|---|---|
| | Untreated | | (5 oz) | | (7 oz) | | (14 oz) | |
| Yellow Poplar | 10.1 | cm³ | 8.7 | cm³ | 14.7 | cm³ | 11.4 | cm³ |
| (Liriodendron | | | | | | | | |
| tulipifera) | | | | | | | | |
| Red Maple | 9.1 | cm³ | 7.4 | cm³ | 18.0 | cm³ | 18.7 | cm³ |
| (Acer rubrum) | | | | | | | | |
| Chestnut Oak | 24.2 | cm³ | 23.6 | cm³ | 23.5 | cm³ | 20.0 | cm³ |
| (Quercus | | | | | | | | |
| montana) | | | | | | | | |
| Cherrybark Oak | 26.4 | cm³ | 24.9 | cm³ | 32.9 | cm³ | 19.2 | cm³ |
| (Quercus falcata | | | | | | | | |
| var. | | | | | | | | |
| pagodaefolia) | | | | | | | | |
| Chinese Chestnut | 30.1 | cm³ | 21.3 | cm³ | 25.8 | cm³ | 20.6 | cm³ |
| (Castanea | | | | | | | | |
| mollissima) | | | | | | | | |
| Sweetgum | 22.6 | cm³ | 22.0 | cm³ | 16.8 | cm³ | 23.1 | cm³ |
| (Liquidambar | | | | | | | | |
| styraciflua) | | | | | | | | |
| Cottonwood | 82.3 | cm³ | 156.7 | cm³ | 148.6 | cm³ | 177.6 | cm³ |
| (Populus | | | | | | | | |
| deltoides) | | | | | | | | |
| Sycamore | 92.8 | cm³ | 83.9 | cm³ | 104.7 | cm³ | 171.6 | cm³ |
| (Acer | | | | | | | | |
| pseudoplatanus) | | | | | | | | |
| Hybrid Poplar | 73.1 | cm³ | 141.7 | cm³ | 90.8 | cm³ | 127.2 | cm³ |
| (Populus hybrid) | | | | | | | | |

The results shown in the above able demonstrate that pre-plant treatment methods according to the invention induce positive growth responses in hardwood trees.

For example, a positive growth response to indaziflam was observed in all treated species, with the exceptions of chestnut oak and Chinese chestnut.

### Example 8—Growth Response for Post-Plant Treatments

Table 8 summarizes growth response data for post-plant treatments. Trees were planted and Esplanade® F was sprayed between 2 and 10 days thereafter.

TABLE 8
Growth Response for Post-Plant Treatments
Stem Volume Index Reported in cm³

| | | | 73 g ai/ha | | 102 g ai/ha | | 204 g ai/ha | |
|---|---|---|---|---|---|---|---|---|
| | Untreated | | (5 oz) | | (7 oz) | | (14 oz) | |
| Yellow Poplar | 10.1 | cm³ | 17.8 | cm³ | 19.7 | cm³ | 19.6 | cm³ |
| (Liriodendron | | | | | | | | |
| tulipifera) | | | | | | | | |
| Red Maple | 9.1 | cm³ | 11.8 | cm³ | 18.1 | cm³ | 15.6 | cm³ |
| (Acer rubrum) | | | | | | | | |
| Chestnut Oak | 24.2 | cm³ | 23.1 | cm³ | 31.7 | cm³ | 27.0 | cm³ |
| (Quercus | | | | | | | | |
| montana) | | | | | | | | |
| Cherrybark Oak | 26.4 | cm³ | 24.7 | cm³ | 33.3 | cm³ | 53.1 | cm³ |
| (Quercus falcata | | | | | | | | |
| var. | | | | | | | | |
| pagodaefolia) | | | | | | | | |
| Chinese Chestnut | 30.1 | cm³ | 24.1 | cm³ | 21.0 | cm³ | 20.1 | cm³ |
| (Castanea | | | | | | | | |
| mollissima) | | | | | | | | |
| Sweetgum | 22.6 | cm³ | 40.5 | cm³ | 32.3 | cm³ | 100.8 | cm³ |
| (Liquidambar | | | | | | | | |
| styraciflua) | | | | | | | | |
| Cottonwood | 82.3 | cm³ | 188.4 | cm³ | 394.9 | cm³ | 787.9 | cm³ |
| (Populus | | | | | | | | |
| deltoides) | | | | | | | | |
| Sycamore | 92.8 | cm³ | 156.7 | cm³ | 180.0 | cm³ | 322.3 | cm³ |
| (Acer | | | | | | | | |
| pseudoplatanus) | | | | | | | | |
| Hybrid Poplar | 73.1 | cm³ | 132.3 | cm³ | 181.7 | cm³ | 630.6 | cm³ |
| (Populus hybrid) | | | | | | | | |

The results shown in the above table demonstrate that post-plant treatment methods according to the invention induce positive growth responses in hardwood trees.

For example, a positive growth response to indaziflam was observed in all treated species except for Chinese chestnut.

### Example 9—Survival Rate for Pre-Plant Treatments

Table 9summarizes survival rate data for pre-plant treatments. Esplanade® F was sprayed and trees were planted between 4 and 5 months thereafter.

TABLE 9
Survival Rate for Pre-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 36.7% | 53.3% | 86.7% | 70.0% |
| (Liriodendron | | | | |
| tulipifera) | | | | |
| Red Maple | 93.3% | 86.7% | 73.3% | 89.3% |
| (Acer rubrum) | | | | |
| Chestnut Oak | 83.3% | 96.7% | 92.7% | 90.0% |
| (Quercus | | | | |
| montana) | | | | |
| Cherrybark Oak | 96.7% | 96.7% | 96.7% | 100% |
| (Quercus falcata | | | | |
| var. | | | | |
| pagodaefolia) | | | | |
| Chinese Chestnut | 96.7% | 96.7% | 87.7% | 96.7% |
| (Castanea | | | | |
| mollissima) | | | | |
| Sweetgum | 100% | 100% | 89.0% | 96.7% |
| (Liquidambar | | | | |
| styraciflua) | | | | |
| Cottonwood | 53.3% | 90% | 92.5% | 100% |
| (Populus | | | | |
| deltoides) | | | | |
| Sycamore | 93.3% | 96.7% | 96.7% | 96.7% |
| (Acer | | | | |
| pseudoplatanus) | | | | |
| Hybrid Poplar | 90.0% | 86.7% | 86.7% | 86.7% |
| (Populus hybrid) | | | | |

The results shown in the above table demonstrate that pre-plant treatment methods according to the invention are safe for use in hardwood trees.

### Example 10—Survival Rate for Post-Plant Treatments

Table 10 summarizes survival rate data for post-plant treatments. Trees were planted and Esplanade® F was sprayed between 2 and 10 days thereafter.

TABLE 10
Survival Rate for Post-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 36.7% | 65.3% | 80.0% | 86.7% |
| (Liriodendron | | | | |
| tulipifera) | | | | |
| Red Maple | 93.3% | 80.0% | 70.0% | 73.3% |
| (Acer rubrum) | | | | |
| Chestnut Oak | 83.3% | 86.7% | 90.0% | 83.3% |
| (Quercus | | | | |
| montana) | | | | |
| Cherrybark Oak | 96.7% | 100% | 96.7% | 100% |
| (Quercus falcata | | | | |
| var. | | | | |
| pagodaefolia) | | | | |
| Chinese Chestnut | 96.7% | 100% | 100% | 96.7% |
| (Castanea | | | | |
| mollissima) | | | | |
| Sweetgum | 100% | 100% | 100% | 100% |
| (Liquidambar | | | | |
| styraciflua) | | | | |
| Cottonwood | 53.3% | 86.7% | 93.3% | 76.7% |
| (Populus | | | | |
| deltoides) | | | | |
| Sycamore | 93.3% | 90.0% | 100% | 93.3% |
| (Acer | | | | |
| pseudoplatanus) | | | | |
| Hybrid Poplar | 90.0% | 86.7% | 90.0% | 70.0% |
| (Populus hybrid) | | | | |

The results shown in the above table demonstrate that post-plant treatment methods according to the invention are safe for use in hardwood trees.

### Example 11—Phytotoxicity for Pre-Plant Treatments

Table 11 summarizes phytotoxicity data for pre-plant treatments. Esplanade® F was sprayed and trees were planted between 4 and 5 months thereafter Phytotoxicity was assessed on a scale of 1 to 10.

TABLE 11
Phytotoxicity for Pre-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 4.37 | 1.57 | 3.77 | 2.87 |
| (Liriodendron | | | | |
| tulipifera) | | | | |
| Red Maple | 0.3 | 1.91 | 1.6 | 1.1 |
| (Acer rubrum) | | | | |
| Chestnut Oak | 2.17 | 1.77 | 1.8 | 2.5 |
| (Quercus | | | | |
| montana) | | | | |
| Cherrybark Oak | 0.6 | 0.63 | 0.93 | 0.77 |
| (Quercus falcata | | | | |
| var. | | | | |
| pagodaefolia) | | | | |
| Chinese Chestnut | 0.0 | 0.47 | 0.87 | 0.47 |
| (Castanea | | | | |
| mollissima) | | | | |
| Sweetgum | 0.17 | 0.77 | 0.6 | 0.6 |
| (Liquidambar | | | | |
| styraciflua) | | | | |
| Cottonwood | 3.0 | 0.97 | 1.03 | 1.5 |
| (Populus | | | | |
| deltoides) | | | | |
| Sycamore | 0.3 | 0.63 | 0.9 | 0.47 |
| (Acer | | | | |
| pseudoplatanus) | | | | |
| Hybrid Poplar | 0.9 | 0.9 | 1.57 | 1.74 |
| (Populus hybrid) | | | | |

The results shown in the above table demonstrate that pre-plant treatment methods according to the invention are safe for use in hardwood trees.

### Example 12—Phytotoxicity for Post-Plant Treatments

Table 12 summarizes phytotoxicity data for post-plant treatments. Trees were planted and Esplanade® F was sprayed between 2 and 10 days thereafter. Phytotoxicity was assessed on a scale of 1 to 10.

TABLE 12
Phytotoxicity for Post-Plant Treatments

| | | 73 g ai/ha | 102 g ai/ha | 204 g ai/ha |
|---|---|---|---|---|
| | Untreated | (5 oz) | (7 oz) | (14 oz) |
| Yellow Poplar | 4.37 | 1.17 | 2.4 | 2.2 |
| (Liriodendron | | | | |
| tulipifera) | | | | |
| Red Maple | 0.3 | 0.6 | 1.5 | 1.43 |
| (Acer rubrum) | | | | |
| Chestnut Oak | 2.17 | 3.0 | 2.17 | 2.43 |
| (Quercus | | | | |
| montana) | | | | |
| Cherrybark Oak | 0.6 | 0.47 | 1.27 | 1.7 |
| (Quercus falcata | | | | |
| var. | | | | |
| pagodaefolia) | | | | |
| Chinese Chestnut | 0.0 | 0.8 | 0.17 | 0.53 |
| (Castanea | | | | |
| mollissima) | | | | |
| Sweetgum | 0.17 | 0 | 0 | 0.5 |
| (Liquidambar | | | | |
| styraciflua) | | | | |
| Cottonwood | 3.0 | 0.6 | 0.63 | 2.2 |
| (Populus | | | | |
| deltoides) | | | | |
| Sycamore | 0.3 | 1.4 | 0.6 | 0.6 |
| (Acer | | | | |
| pseudoplatanus) | | | | |
| Hybrid Poplar | 0.9 | 1.23 | 0.97 | 2.3 |
| (Populus hybrid) | | | | |

The results shown in the above table demonstrate that post-plant treatment methods according to the invention are safe for use in hardwood trees.

1. A method for promoting plant health and development of a hardwood tree comprising applying to a hardwood tree, part thereof, and/or habitat thereof a composition comprising one or more cellulose biosynthesis inhibitors.

2. The method according to claim 1, wherein the composition comprises 0.0001% to 75% of the cellulose biosynthesis inhibitors by weight of the composition.

3. The method according to claim 1, wherein the composition comprises 0.001% to 50% of the cellulose biosynthesis inhibitors by weight of the composition.

4. The method according to claim 1, wherein the composition comprises 0.01% to 33% of the cellulose biosynthesis inhibitors by weight of the composition.

5. The method according to claim 1, wherein the composition comprises 0.1% to 20% of the cellulose biosynthesis inhibitors by weight of the composition.

6. The method according to claim 1, wherein the composition is applied at a rate of between 0.1 g ai/ha and 10,000 g ai/ha.

7. The method according to claim 1, wherein the composition is applied at a rate of between 1 g ai/ha and 1,000 g ai/ha.

8. The method according to claim 1, wherein the composition is applied at a rate of between 5 g ai/ha and 750 g ai/ha.

9. The method according to claim 1, wherein the composition is applied at a rate of between 10 g ai/ha and 500 g ai/ha.

10. The method according to claim 1, wherein the hardwood tree belongs to a genus selected from the group consisting of Acer, Castanea, Eucalyptus, Liquidambar, Liriodendron, Populus, and Quercus.

11. The method according to claim 1, wherein the hardwood tree is selected from the group consisting of Acer pseudoplatanus (sycamore), Acer rubrum (red maple), Castanea mollissima (Chinese chestnut), Eucalyptus benthamii (eucalyptus), Liquidambar styraciflua (sweetgum), Liriodendron tulipifera (yellow poplar), P. deltoides (cottonwood), P. hybrid (hybrid poplar), Quercus. alba (white oak), Quercus falcata var. pagodaefolia cherrybark oak), or Quercus montana (chestnut oak).

12. The method according to claim 1, wherein the composition comprising a cellulose biosynthesis inhibitor is applied in a pre-plant step.

13. The method according to claim 1, wherein the composition comprising a cellulose biosynthesis inhibitor is applied in a post-plant step.

14. The method according to claim 1, wherein the cellulose biosynthesis inhibitor is indaziflam.

15-16. (canceled)
